(19) United States
(12) Patent Application Publication
(10) Pub. No.: US 2019/0355126 A1
(43) Pub. Date: Nov. 21, 2019

(54) IMAGE FEATURE EXTRACTION METHOD AND SALIENCY PREDICTION METHOD USING THE SAME

(71) Applicant: NATIONAL TSING HUA UNIVERSITY, HSINCHU (TW)

(72) Inventors: Min SUN, Baoshan Township (TW); Hsien-Tzu CHENG, Hsinchu City (TW); Chun-Hung CHAO, Hsinchu City (TW); Tyng-Luh LIU, New Taipei City (TW)

(21) Appl. No.: 16/059,561

(22) Filed: Aug. 9, 2018

(30) Foreign Application Priority Data
May 21, 2018 (TW) 107117158

(51) Int. Cl. G06T 7/174; G06N 3/08; G06T 3/00; G06N 3/04

(52) U.S. Cl. CPC G06T 7/174; G06N 3/08; G06T 3/0012; G06T 2207/20081; G06T 2207/10028; G06T 2207/20084; G06N 3/04

(57) ABSTRACT

An image feature extraction method for a 360° image includes the following steps: projecting the 360° image onto a cube model to generate an image stack including a plurality of images having a link relationship; using the image stack as an input of a neural network, wherein when operation layers of the neural network performs padding operation on one of the plurality of images, the link relationship between the plurality of adjacent images is used such that the padded portion at the image boundary is filled with the data of neighboring images in order to retain the characteristics of the boundary portion of the image; and by the arithmetic operation of the neural network of such layers with the padded feature map, an image feature map is generated.

### CROSS-REFERENCE TO RELATED APPLICATION

This application claims priority from Taiwan Patent Application No. 107117158, filed on May 21, 2018, in the Taiwan Intellectual Property Office, the content of which is hereby incorporated by reference in its entirety for all purposes.

### BACKGROUND OF THE INVENTION

### 1. Field of the Invention

The present invention generally relates to an image feature extraction method using a neural network, more particularly, an image feature extraction method using a cube model to perform cube padding, with a feature to process an image formed at the pole complete and without distortion, so as to match the user's requirements.

### 2. Description of the Related Art

In recent years, image stitching technology has become rapidly developed, and a 360° image is widely applied to various fields due to the advantage of not having a blind spot. Furthermore, a machine learning method can also be used to develop predictions and learning processes for effectively generating the 360° image without the disadvantage of dead ends.

Most conventional 360° images are generated by equidistant cylindrical projection (EQUI) which is also called as rectangular projection. However, equidistant cylindrical projection may cause images to be distorted in the north pole and south poles (that is, the portions near the poles) and also produce extra pixels (that is, image distortion), thereby causing an inconvenience in object recognition and sequential application. Furthermore, when the computer vision system processes the conventional 360° images, the distortion of the image caused by this projection manner also reduces the accuracy of the prediction.

Therefore, what is needed is to develop an image feature extraction method using a machine learning structure to effectively solve the problem of pole distortion in a 360° image for the saliency prediction of the 360° image, and further to more quickly and accurately generate and output the features of the 360° image.

### SUMMARY OF THE INVENTION

The present invention provides an image feature extraction method in which the object repaired by the conventional image repair method may still have defects or distortions causing failure in the extracting features of the image.

According to an embodiment, the present invention provides an image feature extraction method comprised of five steps. The first step is projecting a 360° image to a cube model to generate an image stack comprising a plurality of images with a link relationship to each other. The next step uses the image stack as an input of a convolution neural network, wherein when an operation layer of the neural network is used to perform a padding computation on the plurality of images. The to-be-padded data is obtained from the neighboring images of the plurality of images according to the link relationship, so as to reserve the features of the image boundary. In the third step the operation layer of the convolution neural network is used to compute and generate a padded feature map. Also during this step, an image feature map is extracted from the padded feature map, and by using a static model to extract static saliency map from the image feature maps the procedure is repeated. The fourth step optionally adds a long short-term memory (LSTM) layer in the operation layer of the convolution neural network to compute and generate the padded feature map. The fifth and final step uses a loss function to modify the padded feature map, in order to generate a temporal saliency map.

The 360° image can be presented in any 360-degree view manner which is preferable.

The present invention is not limited to the six-sided cubic model described, and may comprise a polygonal model. For example, an eight-sided model or a twelve-sided model may be used.

The link relationship of the images of the image stack is generated by a pre-process of projecting the 360° image into the cube model, and the pre-process performs the overlapping method on the image boundary between faces of the cube model, so as to perform adjustment in the CNN training.

According to the relative locations thereof formed by the link relationship, a plurality of images between multiple image stacks is formed.

The processed image stack can be used as the input of the neural network after the plurality of images of the image stack in the link relationship is checked and processed by using the pre-processed cube model.

The image stack is used to train the operation layer of the convolution neural network. In this training process, the operation layer is trained for image feature extraction. During the training process, the padding computation (that is, the cube padding) is performed on the neighboring images of the image stack formed by the plurality of images processed by the cube model. The plurality uses the link relationship, wherein the neighboring image can be the images between two adjacent faces of the cube model. In this way, the image stack can include neighboring images in the up direction, the down direction, the left direction and the right direction. This allows for checking the features of the image boundary according to the overlapping relationship of the neighboring images, and the boundary of the operation layer can be used to check the range of the image boundary.

A dimension of a filter of the operation layer controls the range of the to-be-padded data. The range of the operation layer can further comprise a range of the to-be-padded data of the neighboring images.

After being processed by the operation layer of the convolution neural network to check the label and the overlapping relationship of the neighboring images, the image stack is processed to be the padded feature map. In the present invention, the operation layer of the neural network is trained according to the image stack to check the label and overlapping relationship of the neighboring images, so as to optimize the feature extraction efficiency of the CNN training process.

After the operation layer processes the image stack, the plurality of padded feature maps comprising the link relationship to each other can be generated.

The operation layer of the neural network is then trained according to the image stack to check the express and overlapping relationship of the neighboring images. Subsequently, the padded feature map can be generated, and the post-process module can be used to perform max-pooling, inverse projection and up-sampling on the padded feature map to extract the image feature map.

A static model (M_{S}) modification is performed on the image feature map in order to extract a static saliency map. The static model modification can be used to modify the ground truth label on the image feature map, so as to check the image feature and perform saliency scoring on the pixels of each image, thereby generating the static saliency map O^{s}.

An area under curve (AUC) method can be performed before the saliency scoring method. For example, the AUC method can be a linear correlation coefficient (CC), in which AUC-J and AUC-B can be performed, so that any AUC method can be applied to the present invention, and the saliency scoring operation can be performed for the extracted feature map after the AUC.

The saliency scoring operation is used to optimize the performance of the image feature extraction method using the static model and the temporal model with the LSTM. The score of the conventional method can be compared with a baseline such as zero-padding, motion magnitude, ConsistentVideoSal or SalGAN. In this way, the image feature extraction method of the present invention can produce an excellent score according to the saliency scoring manner.

After being processed by the operation layer of the neural network, the image stack can be processed by the LSTM to generate the two padded feature maps having a time continuous feature. The image stack is then formed by the plurality of images projected to the cube model and having the link relationship.

After being processed by the operation layers of the neural network, the image stack can be processed by the LSTM to generate the two padded feature maps having the time continuous feature, and the two padded feature maps can then be modified by using the loss function. The loss function can be mainly used to improve time consistency of two continuous padded feature maps.

Preferably, the operation layers can be use, to compute the image to generate, the plurality of padded feature maps comprising the link relationship to each other, so as to form a padded feature map stack.

Preferably, the operation layers can further comprise a convolutional layer, a pooling layer and the LSTM.

According to an embodiment, the present invention provides a saliency prediction method adapted to the 360° image. This method is comprised of four steps. First, extracting an image feature map of the 360° image, and using the image feature map as a static model. Then, saliency scoring is performed on the pixels of each image of the static model in order to obtain the static saliency map. In the third step, a LSTM is added in an operation layer of a neural network. In this way, a plurality of static saliency maps for different times may be gathered. Additionally, a saliency scoring operation is performed on the plurality of static saliency maps which in turn contributes to a temporal saliency map. Finally, a loss function on the temporal saliency map of the current time point is performed. This optimizes the saliency prediction result of the 360° image at the temporal saliency map at the current time point, according to the temporal saliency map at the previous time point.

According to above-mentioned contents, the image feature extraction method and the saliency prediction method of the present invention have the following advantages.

First, the image feature extraction method and the saliency prediction method can use the cube model based on the 360° image to prevent the image feature map at the pole from being distorted. The parameter of the cube model can be used to adjust the image overlapping range and the deep network structure, so as to reduce the distortion to improve image feature map extraction quality.

Secondly, the image feature extraction method and the saliency prediction method can use a convolutional neural network to repair the images, and then use the thermal images as the completed output image. This allows for the repaired image to be more similar to the actual image, thereby reducing the unnatural parts in the image.

Thirdly, the image feature extraction method and the saliency prediction method can be used in panoramic photography applications or virtual reality applications without occupying great computation power, so that the technical solution of the present invention may have a higher popularization in use.

Fourthly, the image feature extraction method and the saliency prediction method can have better output effect than conventional image padding method, based on saliency scoring result.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The structure, operating principle and effects of the present invention will be described in detail by way of various embodiments which are illustrated in the accompanying drawings.

FIG. 1 is a flow chart of an image feature extraction method of an embodiment of the present invention.

FIG. 2 is a relationship configuration of the image feature extraction method of an embodiment of the present invention, after the 360° image is input into the static model trained by the CNN with the LSTM.

FIG. 3 is a schematic view of computation modules of an image feature extraction method applied in an embodiment of the present invention.

FIG. 4 is a VGG-16 model of an image feature extraction method of an embodiment of the present invention.

FIG. 5 is a ResNet-50 model of an image feature extraction method of an embodiment of the present invention.

FIG. 6 is a schematic view of a three dimensional image used in an image feature extraction method of an embodiment of the present invention.

FIG. 7 shows a grid-line view of a cube model and a solid-line view of a 360° image of an image feature extraction method of an embodiment of the present invention.

FIG. 8 shows a configuration of six faces of a three dimensional image of an image feature extraction method of an embodiment of the present invention.

FIG. 9 is actual comparison result between the cube padding and the zero-padding of an image feature extraction method of an embodiment of the present invention.

FIG. 10 is a block diagram of a LSTM of an image feature extraction method of an embodiment of the present invention.

FIGS. 11A to 11D show the actual extraction effects of an image feature extraction method of an embodiment of the present invention.

FIGS. 12A and 12B show heat map and actual plan view of actual extracted features of the image feature extraction method of an embodiment of the present invention.

FIG. 13A and FIG. 13B show actual extracted features and the heat maps from different image sources of an image feature extraction method of an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It should be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

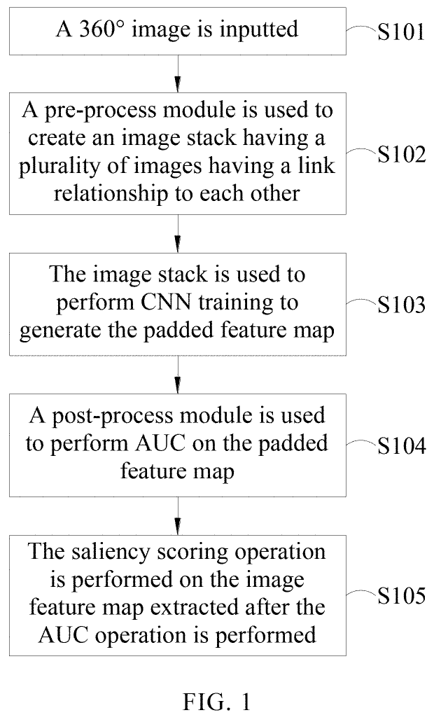

Please refer to FIG. 1, which is a flow chart of an image feature extraction method of a method of the present invention. The method comprises five steps, labelled S101 to S105.

In step S101, a 360° image is input. The 360° image can be obtained by using an image capture device. The image capture device can be wild-360 and Drone, or any other similar capture device.

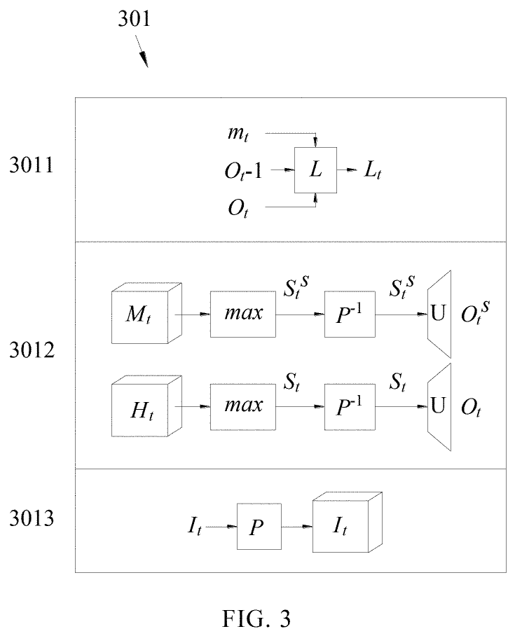

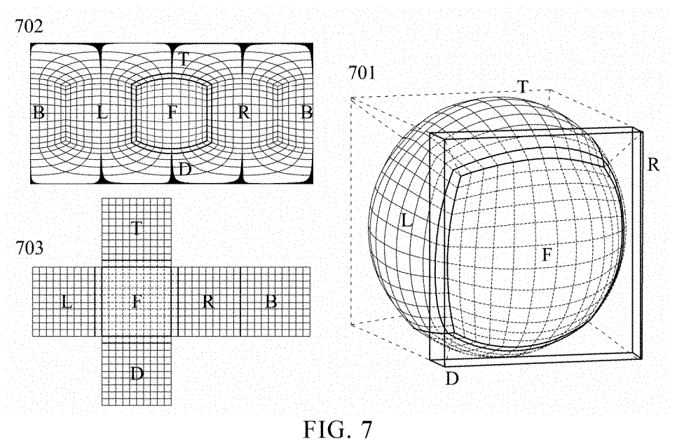

In step S102, the pre-process module is used to create an image stack having a plurality of images having a link relationship to each other. For example, the pre-process module 3013 can use the six faces of a cube model as the plurality of images corresponding to the 360° image, and the link relationship can be created by using overlapping manner on the image boundary. The pre-process module 3013 shown in FIG. 1 can be referred to the pre-process module 3013 shown in FIG. 3. The 360° image It can be processed by the pre-process model P to generate the 360° image It corresponding to the cube model. Please refer to FIG. 7, which shows the cube model. The 360° image mapped to the cube model 701 is expressed by circular grid lines, corresponding to B face, D face, F face, L face, R face and T face of the cube model, respectively. Furthermore, the link relationship can be created by the overlapping method described in step S101 and also can be created by checking the neighboring images. The cube model 903 also shows a schematic view of F face of the cube model, and the plurality of images which has the checked link relationship can be processed by the cube model of the pre-process module to form the image stack. The image stack then can be used as the input of the neural network.

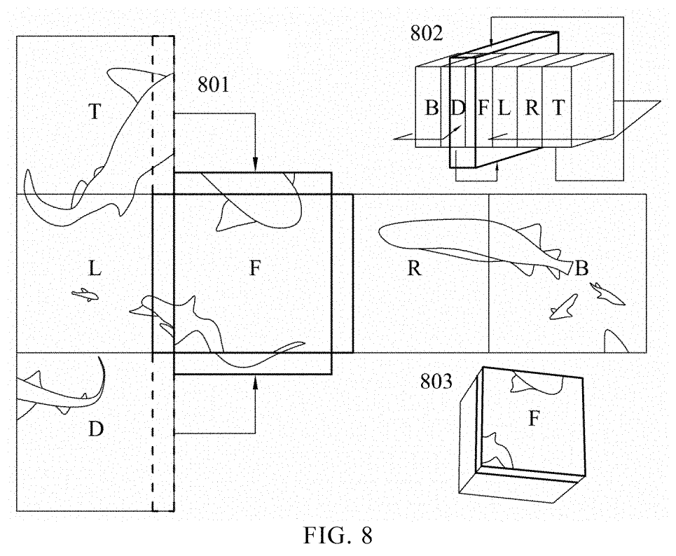

In step S103, the image stack is used to perform the CNN training, and the flow of the CNN training will be described in paragraph below. The operation of obtaining the range of the operation layer of the CNN training can comprise: obtaining a range of the to-be-padded data according to the neighboring images, and using the dimension of the filter of the operation layer to control overlapping of the image boundary of the neighboring images. This allows optimization of the feature extraction and efficiency of the CNN training. The padded feature map can be generated after the CNN training has been performed according to the image stack. As shown in FIG. 8, the cube padding and the neighboring image can be illustrated according to cube models 801, 802 and 803. For example, the cube model 801 can be shown by an exploded view of the cube model, and F face is one of the six faces of the cube model, and four faces adjacent to the F face are the T face, L face, R face and D face, respectively. The cube model 802 can further express the overlapping relationship between the images. The image stack can be used as an input image, and the operation layer of the neural network can be used to perform cube padding on the input image to generate the padded feature map.

In step S104, a post-process module is used to perform the max-pooling, the inverse projection and the up-sampling on the padded feature map, to extract the image feature map from the padded feature map, and then perform the AUC, such as determining a linear correlation coefficient, in which AUC-J and AUC-B are performed on the image feature map. Any AUC can be applied to the image feature extraction method of the present invention, and after AUC is performed, the image feature map can be extracted from the padded feature map.

In step S105, the saliency scoring operation is performed on the image feature map extracted after the AUC operation is performed. In this way, the static model and the temporary model is optimized using the LSTM. A saliency scoring operation is then used to compare scores of the conventional method and a baseline such as zero-padding, motion magnitude, Consistent VideoSal or SalGAN. As a result, the method of the present invention can produce an excellent score according to saliency scoring.

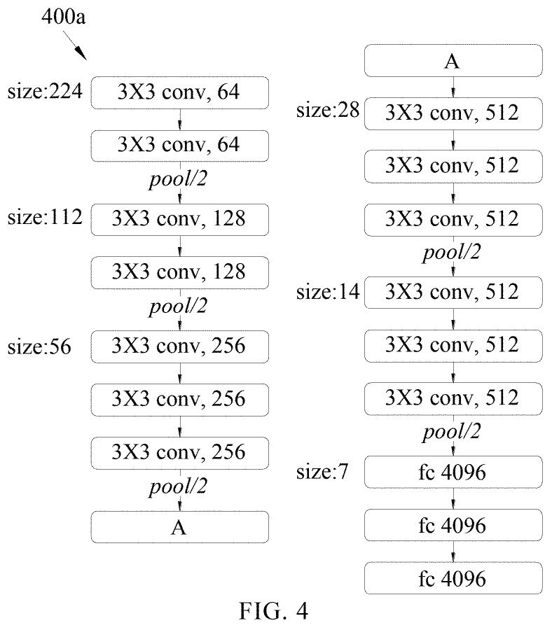

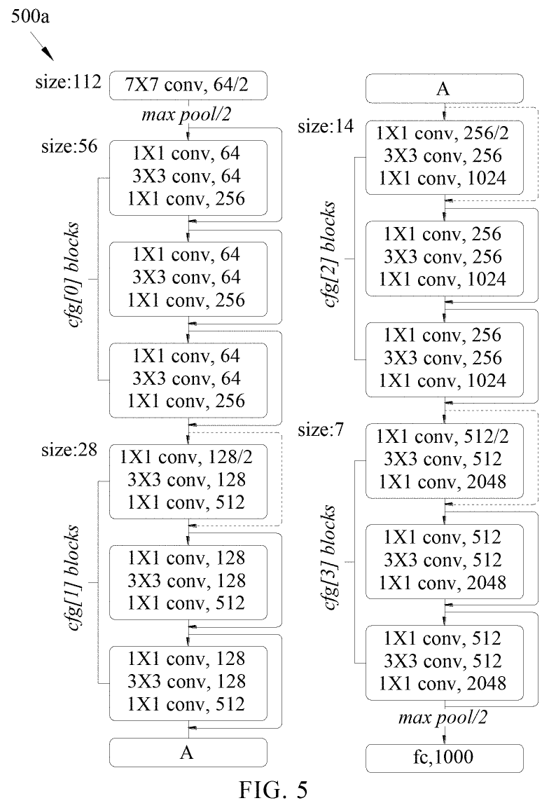

For example, the image stack in step S102 can be input into the two CNN training models such as the VGG-16 400a as shown in FIG. 4 and the ResNet-50 shown in FIG. 5 for neutral network training. The operation layer of CNN to be trained can include convolutional layers and pooling layers. In an embodiment, the convolutional layer can use 7×7 convolutional kernels, 3×3 convolutional kernels and 1×1 convolutional kernels. In FIGS. 4 and 5, the grouped convolutional layers are named by numbers and English abbreviations.

FIGS. 4 and 5 show the VGG-16 model 400a and the ResNet-50 model 500a used in the image feature extraction method of the present invention, respectively. The operation layer in these model includes the convolutional layers and the pooling layers. The dimension of the filter controls the range of the operation layer, and the dimension of the filter also controls the boundary range of the cube padding. The VGG-16 model 400a uses 3×3 convolutional kernels, and the first group of convolutional kernels includes two first convolutional layer 3×3 conv, 64, and size: 224, and a first cross convolutional layer (that is, a first pooling layer pool/2). The second group of convolutional kernels includes two second convolutional layers conv, 128, and size: 112, and second cross convolutional layer (that is, a second pooling layer pool/2). The third group of convolutional kernels includes three third convolutional layers 3×3 conv, 256, and size: 56 and a third cross convolutional layer (that is, a third pooling layer pool/2). The fourth group of convolutional kernels includes three fourth convolutional layer 3×3 conv, 512, size: 28 and a fourth cross convolutional layer (that is, a fourth pooling layer pool/2). The fifth group of convolutional kernels includes three fifth convolutional layer 3×3 conv, 512, size: 14 and a fifth cross convolutional layer (that is, a fifth pooling layer pool/2). The sixth group of convolutional kernels is size: 7 for the resolution scan. The padded feature map generated by these groups of convolutional kernels can have the same dimensions, the size means the resolution, the number labelled in operation layer means the dimensions of the feature, and the dimensions can control the range of the operation layer and control the boundary range of the cube padding operation of the present invention. The functions of the convolutional layers and the pooling layers both are mixing and dispersing the information from previous layers, and the later layers have a larger receptive field, so as to extract the features of the image in different levels. The difference between the cross convolutional layer (that is, the pooling layer) and the normal convolutional layer is that the cross convolutional layer is set with a step size of 2, so the padded feature map outputted from the cross convolutional layer has a half size, thereby effectively interchanging information and reducing computation complexity.

The convolutional layers of the VGG-16 model 400a are used to integrate the information output from previous layer, so that the gradually reduced resolution of the padded feature map can be increased to the original input resolution; generally, the magnification is set as 2. Furthermore, in the design of neural network of this embodiment, the pooling layer is used to merge the previous padded feature map with the convolutional result. This acts to transmit the processed data to later convolutional layers, and as a result, the first few layers can have intensive object structure information for prompting and assisting the generation result of the convolutional layer, to make the generation result approximate original image structure. In this embodiment, the images are input to the generation model and processed by convolutional and conversion process to generate output image. However, the layer type and layer number of the convolutional layer of the present invention is not limited to the structure shown in figures. The layer type and layer number of the convolutional layer can be adjusted according to the inputted images with different resolutions. Such modification based on the above-mentioned embodiment is covered by scope of the present invention.

The ResNet-50 model 500a uses 7×7, 3×3 and 1×1 of convolutional kernels, and the first group of convolutional kernels includes a first convolutional layer with 7×7 convolutional kernel conv, 64/2, and a first cross convolutional layer (that is, first max pooling layer max pool/2). The second group of convolutional kernels has size: 56 and includes three sub-groups of operation layers which each include: a second convolutional layer 1×1 conv, 64, a second convolutional layer 3×3 conv, 64, and a second convolutional layer 1×1 conv, 64. The convolutional layers expressed by solid line and the cross convolutional layer expressed by dashed line are linked by second max pooling layers max pool/2. The third group of convolutional kernels has size: 28 and includes three sub-groups of operation layers which each include three third convolutional layers. The first sub-group includes 1×1 conv, 128/2, 3×3 conv, 64, and 1×1 conv, 512, the second sub-group includes 1×1 conv, 128, 3×3 conv, 128, and 1×1 conv, 512, the third sub-group includes 1×1 conv, 128, 3×3 conv, 128, and 1×1 conv, 512. The convolutional layers and the cross convolutional layers are linked by a third max pooling layer max pool/2. The fourth group has a size: 14 and includes three sub-groups of operation layers which each includes three fourth convolutional layers, the first sub-group includes 1×1 conv, 256/2, 3×3 conv, 256 and 1×1 conv, 1024. The second sub-group includes 1×1 conv, 256, 3×3 conv, 256, and 1×1 conv, 1024 The third sub-group includes 1×1 conv, 256, 3×3 conv, 256, and 1×1 conv, 1024. The convolutional layers and the cross convolutional layers are linked by a fourth max pooling layer max pool/2. The fifth sub-group has a size: 7 and includes three sub-groups of operation layers. The first sub-group includes 1×1 conv, 512/2, 3×3 conv, 512, and 1×1 conv, 2048, the second sub-group includes 1×1 conv, 512, 3×3 conv, 512, and 1×1 conv, 2048. The third sub-group includes 1×1 conv, 512, 3×3 conv, 512, and 1×1 conv, 2048, and the convolutional layers are linked to each other by fifth max pooling layers max pool/2. The cross convolutional layers are linked to each other by average pooling layer avg pool/2. The sixth group of the convolutional layers is linked with the average pooling layer. The sixth group has a size: 7 and performs a resolution scan. The padded feature map output from the groups have the same dimensions, and each layer is labelled by number in parentheses. The size labelled in the layer means the resolution of the layer, the number labelled in the operation layer means the dimensions of the feature, the dimensions can control the range of the operation layer and also control the boundary range of the cube padding of the present invention. The functions of the convolutional layer and the pooling layer both are to mix and disperse the data from previous layers, the later layer has larger receptive field, so as to extract the features of the image in different levels. For example, the cross convolutional layer can have a step size of 2, so the resolution of the padded feature map processed by the cross convolutional layer becomes half, so as to effectively interchange information and reduce computation complexity.

The convolutional layers of the ResNet-50 model 500a are used to integrate the data output from the former layers, so that the gradually-reduced resolution of the padded feature map can be increased to the original input resolution. For example, the magnification can be set as 2. Furthermore, in the design of a neural network, the pooling layer is used to link the previous padded feature map with the current convolutional result Then the computational result is transmitted to another later layer, so that the first few layers can have intensive object structure information for prompting and assisting the generation result of the convolutional layer. This in turn, makes the generation result approximate to the original image structure. Real-time image extraction can be performed on the data block having the same resolution without waiting for completion of the entire CNN training. The generation model of this embodiment can receive the image, and perform aforementioned convolution and conversion process, to generate image. However, the layer type and layer number of the convolutional layers of the present invention is not limited to the structure shown in figures. In an embodiment, for images with different resolutions, the convolutional layer type and layer number of the generation model can be adjusted, and such that modification of the embodiment is also covered by the claim scope of the present invention.

The image feature extraction method of the present invention uses the CNN training models VGG-16 and ResNet-50 as shown in FIGS. 4 and 5, as recorded in “Deep Residual Learning for Image Recognition”, arXiv:1512.03385 and “Very Deep Convolutional Networks for Large-Scale Image Recognition”, arXiv:1409.1556 of the IEEE Conference on Computer Vision and Pattern Recognition. The image feature extraction method of the present invention uses the cube model to convert the 360° image, and uses two CNN training models to perform cube padding, to generate the padded feature map.

In step S103, the image stack becomes a padded feature map through the CNN training model, and the post-process module performs max-pooling, inverse projection, and up-sampling on the padded feature map, so as to extract image feature map from the padded feature map which is processed by the operation layers of the CNN.

In step S103, the post-process module processes the padded feature map to extract the image feature map, and a heat map is then used to extract heat zones of the image feature map for comparing the extracted image feature with the features of the actual image, so as to compare whether the extracted image features are correct.

In step S103, by processing the image stack using the operation layers of the CNN training models, the LSTM can be added and the temporal model training can be performed, and a loss function can be applied in the training process, so as to strengthen the time consistency of two continuous padded feature maps trained by the LSTM.

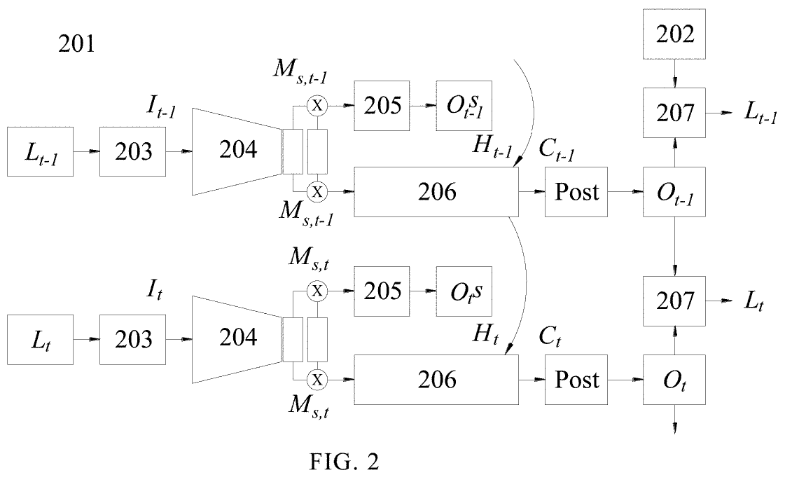

Please refer to FIG. 2, which is a flow chart of inputting the 360° image to the static model and the temporal model for CNN training, according to an embodiment of an image feature extraction method of the present invention. In FIG. 2, each of 360° images Iₜ and Iₜ₋₁ is inputted into and processed by the pre-process module 203. They are then input into the CNN training models 204 to perform cube padding CP on the 360° images Iₜ and Iₜ₋₁. This allows to obtain the padded feature maps M_{s,t-1}, M_{s,t}. The padded feature maps M_{s,t-1}, M_{s,t} are then processed by the post-process modules 205 to generate the static saliency maps O^{S}ₜ₋₁, and O^{S}ₜ. At the same time, the padded feature maps M_{s,t-1}, M_{s,t} can also be processed by the LSTM 206. The post-process module 205 processes the process result of the LSTM 206 and the static saliency maps O_{St-1}, and O_{St}. The output Oₜ₋₁ and Oₜ of the post-process module 205 is then modified by the loss module 207 to generate the temporal saliency maps Lₜ₋₁, and Lₜ. The relationship between the components shown in FIG. 2 will be described in the paragraph about the illustration of the pre-process module 203, the post-process module 205, and the loss module 207. The 360° image can be converted according to the cube model to obtain six two-dimensional images corresponding to six faces of the cube model. Using the six images as a static model M_{S} (which is also labelled as reference number 201), the static model M_{S} is multiplied with conventional feature M₁ and weights W_{fc} of the connected layer in the convolutional layer. The calculation equation can be expressed below,

M_{S}=M₁*W_{fc}

wherein M_{S}∈R^{6×K×w×w}, M₁∈R^{6×c×w×w}, W_{fc}∈R^{c×K×1×1}, c is a number of channels, w is a width of corresponding feature, the symbol * means convolutional computation, K is a number of classes of the pre-trained model in specific classification data-set. In order to generate the static saliency map S, the conventional feature M₁ is shifted pixel-wise in the inputted image along the dimension to perform convolution computation, so as to generate the M_{S}.

Please refer to FIG. 3, which shows the module 301 used in the image feature extraction method of the present invention. The module 301 includes a loss module 3011, a post-process module 3012, and a pre-process module 3013.

The continuous temporal saliency maps Oₜ and Oₜ₋₁ output from the LSTM process, and the padded feature map Mₜ are inputted into the loss module 3011 which performs loss minimization to form the temporal saliency diagram Lₜ, which can strengthen the time consistency of two continuous padded feature maps processed by the LSTM. The detail of the loss function will be described below.

The post-process module 3012 can perform inverse projection P⁻¹ on the data processed by the max-pooling layers, and then perform up-sampling, so as to recover the padded feature map Mₜ and heat map Hₜ, which are processed by projecting to the cube model and by cube padding process, to the saliency maps Oₜ, and O^{S}ₜ.

The pre-process module 3013 is performed on the images before the images are projected to the cube model. The pre-process module 3013 is used to project the 360° image Iₜ into the cube model to generate an image stack Iₜ formed by the plurality of images having the link relationship with each other.

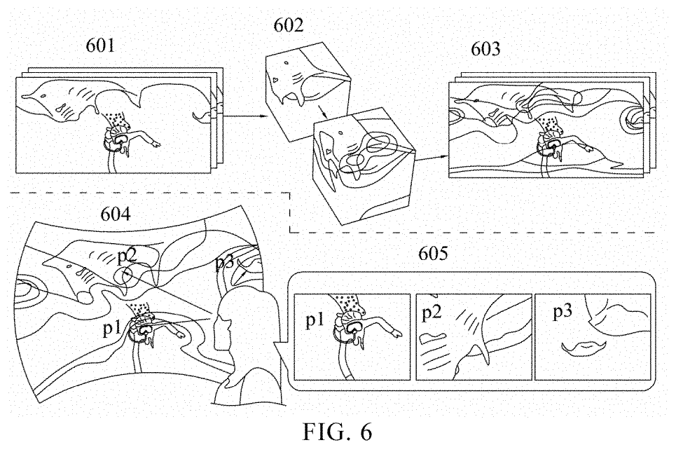

Please refer to FIG. 6, which shows a configuration of six faces of a cube model and a schematic view of image feature of the cube model of an image feature extraction method of the present invention. As shown in FIG. 6, the actual 360° images are obtained (stage 601), and are projected to the cubemap mode (stage 602). The images are then converted to thermal images 603 corresponding to the actual 360° image 601 for solve boundary case (stage 603). The image feature map is used to express the image features extracted from the actual heat map (stage 604), and the viewpoints P1, P2 and P3 on the heat map can correspond to the feature map application viewed through normal field of views (NFoV) (stage 605).

Please refer to FIG. 7, which shows the 360° image based on the cube model and shown by solid lines. The six faces of the cube model are B face, D face, F face, L face, R face and T face, respectively, and are expressed by grid lines. Compared the six faces processed by the zero-padding method 702 with the six faces processed by the cube padding method 703, it is obvious that edge lines of the six faces processed by the zero-padding method 702 are twisted,

The equation for the cube model is expressed below:

$${S}^{j} ( x , y ) = \begin{matrix}Max \\ K\end{matrix} \{ {M}_{S}^{j} ( k , x , y ) \} ; ∀ j ∈ \{ B , D , F , L , R , T \}$$

wherein S^{j} (x, y) is a location (x, y) of the saliency scoring S in the face j.

FIG. 8 shows the six faces corresponding to actual image, the six faces includes B face, D face, F face, L face, R face and T face, respectively. The exploded view 801 of the cube model can use to determine the overlapping portion between the adjacent faces, according to cube model processing order and schematic view of image boundary overlapping method. The F face can be used to confirm the overlapping portions.

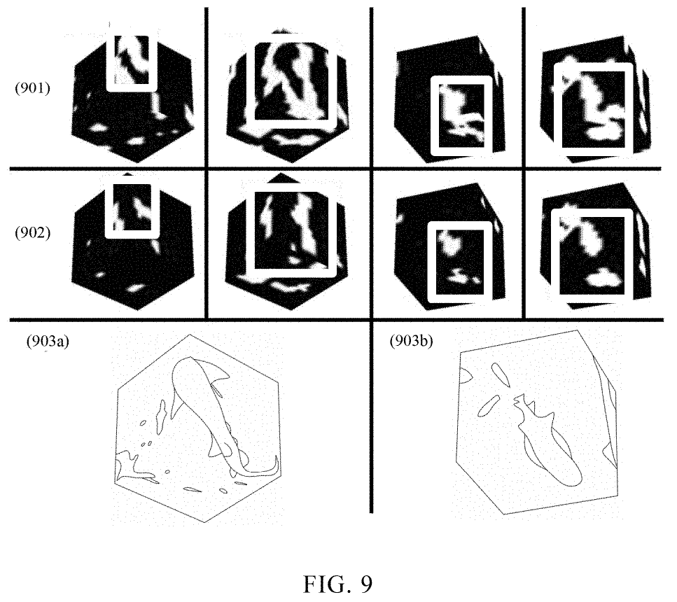

Please refer FIG. 9, which shows saliencies of images of feature maps generated by cube model method and conventional zero-padding method for comparison. As shown in FIG. 9, the white areas of the black and white feature map 901 generated by the image feature extraction method with cube padding are larger than the white areas of the black and white feature map generated by the image feature extraction method 902 with zero-padding. This indicates that the image processed by the cube model can extract the image features more easily than the image processed by zero-padding. The faces 903a and 903b are actual image maps processed by the cube model.

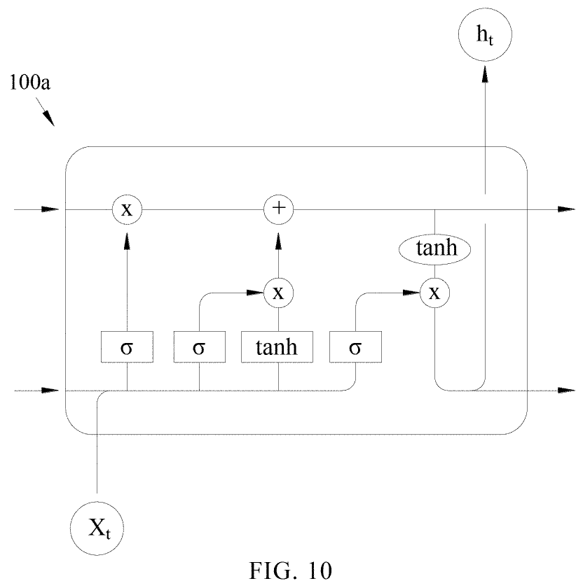

The aforementioned contents are related to the static image process. Next, the time model 202 shown in FIG. 2 can be combined with the static image process, so as to add the static images with a timing sequence for generating continuous temporal images. The block diagram of the LSTM 100a of FIG. 10 can express the time model 202. The operation of the LSTM is expressed below,

iₜ=σ(Wₓᵢ*M_{S,t}+Wₕᵢ*Hₜ₋₁+W_{ci}∘Cₜ₋₁+bᵢ)

fₜ=σ(W_{xf}*M_{S,t}W_{hf}*Hₜ₋₁+W_{cf}∘W_{cf}∘Cₜ₋₁+b_{f})

gₜ=tan h(W_{xc}*Xₜ+W_{hc}*Hₜ₋₁+b_{c})

Cₜ=iₜ∘gₜ+fₜ∘Cₜ₋₁

oₜ=σ(Wₓₒ*Mₜ+Wₕₒ*Hₜ₋₁+W_{co}∘Cₜ+bₒ)

Hₜ=oₜ∘ tan h(Cₜ)

wherein the symbol “∘” means multiplication of element and element, σ( ) is a S function, and all W* and b* are model parameters which can be determined by training process, and i is an input value, f is an ignore value, and o is a control signal between 0 to 1, g is a converted input signal with a value [−1, 1], C is a value of memory unit, H∈R^{6×K×w×w} serves as an expression manner of output and regular input, M_{S} is an output of the static model, and t is a time index and can be labelled as subscript to indicate a time step size. The LSTM is used to process the six faces (B face, D face, F face, L face, R face and T face) processed by the cube padding.

The calculation equation is expressed below

$${S}_{t}^{j} ( x , y ) = \begin{matrix}Max \\ K\end{matrix} \{ {M}_{t}^{j} ( k , x , y ) \} ; ∀ j ∈ \{ B , D , F , L , R , T \}$$

wherein Sₜ^{j}(x, y) is a primary saliency scoring from the location (x, y) to a location on the face j after a time step t. The temporal consistent loss can be used to reduce the effect of the warp or smoothness of each pixel displacement on the model correlation between the discrete images. Therefore, the present invention uses three loss functions to train the time model, and to optimize and reconstruct the loss L^{recons}, the smoothness loss L^{smooth}, the motion masking loss L^{motion} along the time line. The total loss function of each time step t can be expressed as,

Lₜ^{total}=λᵣLₜ^{recons}+λₛLₜ^{smooth}+λₘLₜ^{motiom}

wherein the L^{recons} is temporal reconstruction loss, the L^{smooth} is smoothness loss, the L^{motiom} is motion masking loss, and the total loss function for each time step t can be determined by the adjustment of the temporal consistent loss,

The temporal reconstruction loss equation:

$${L}_{t}^{recons} = \frac{1}{N} {\sum }^{N} \vert \vert Ot ( p ) - Ot - 1 ( p + m ) \vert \vert 2$$

In the temporal reconstruction loss equation, the same pixels cross different time steps t have similar saliency scoring, so that this equation is beneficial for more accurately repairing the feature maps to have similar motion modes.

The smoothness loss function

$${L}_{t}^{smooth} = \frac{1}{N} {\sum }^{N} \vert \vert Ot ( p ) - Ot - 1 ( p ) \vert \vert 2$$

The smoothness loss function can be used to limit responses of the nearby frames to be similar, and also suppresses noises and drift of the temporal reconstruction loss equation and the motion masking loss equation.

The motion masking loss function

$${L}_{t}^{motion} = \frac{1}{N} {\sum }^{N} \vert \vert Ot ( p ) - {O}_{t}^{m} ( p ) \vert \vert 2$$

$${O}_{t}^{m} = \{ \begin{matrix}0 , if \vert m ( p ) \vert \leq ∈ ; \\ Ot ( p ) ,\end{matrix}$$

In the motion masking loss equation, if the motion mode remain stable within step size for long time, the motion magnitude is decreased by ∈, the video saliency scoring of the non-motional pixel should lower than the patch.

The plurality of static saliency maps at different times are gathered, and saliency scoring is performed on the static saliency maps to obtain the temporal saliency map. The loss function is performed, according to the temporal saliency map (Oₜ₋₁) of previous time point, to optimize the temporal saliency map (Oₜ) of the current time point, so as to generate the saliency prediction result of the 360° image.

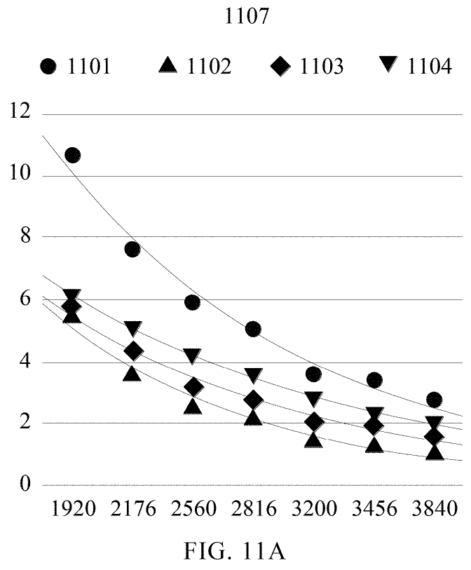

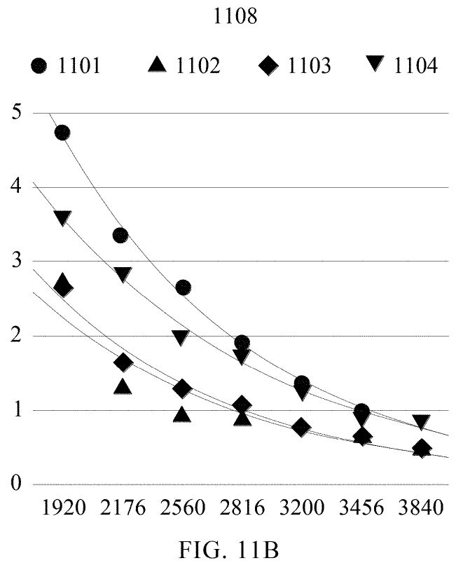

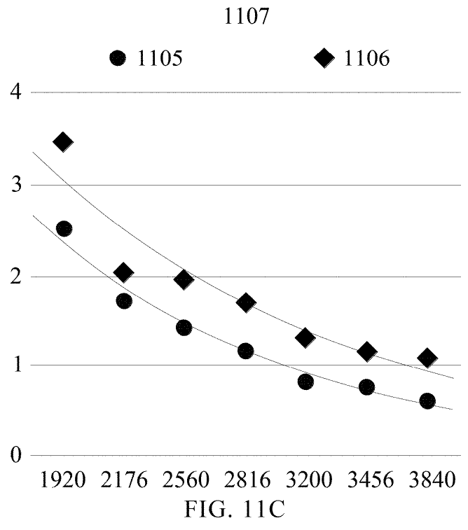

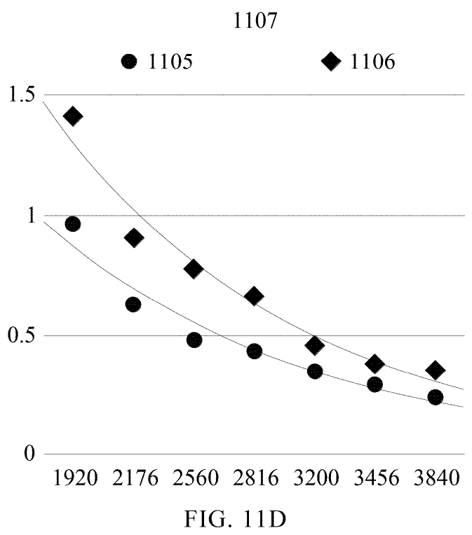

Please refer to FIG. 11, which shows the CNN training process of using the VGG-16 model and the ResNet-50 model, and the temporal model added with LSTM, of image feature extraction method of the static model and the conventional image extraction method. In FIG. 11, the horizontal axe is an image resolution from Full HD: 1920 pixels to 4K: 3096 pixels, and the vertical axe is frames per second (FPS).

The four image analysis methods using the static model are compared.

The first image analysis method is the EQUI method 1102. The six-sided cube of the static model serves as input data to generate the feature map, and the EQUI method is directly performed on the feature map.

The second image analysis method is the cube mapping 1101. The six-sided cube of the static model serves as input data to generate the feature map. The operation layer of the CNN is used to perform zero-padding on the feature map and use the dimensions of the convolutional layers and the pooling layers of the operation layers of the CNN to control the image boundary of the zero-padding result. However, the continuous loss can still be formed on the faces of the cube map.

The third image analysis method is the overlapping method 1103. A cube padding variant is set to make an angle between any adjacent faces 120 degrees, so that the images can have more overlapping portions to generate the feature map. However, the zero-padding is performed by the neural network and the dimensions of the convolutional layers and the pooling layers of the neural network are used to control the image boundary of the zero-padding, so that the continuous loss can still be formed on the faces of the cube after zero-padding method.

The fourth image analysis method is using the present invention directly to input the 360° image into the cube model 1104 for pre-process without the adjustment, and the convolutional layers and the pooling layers of the operation layers of the CNN are used to process the 360° image after the pre-process.

The image feature extraction method of the present invention uses the cube padding model method 1305 and the cube padding to set the overlapping relationship. Using the dimensions of operation layers, convolutional layers and pooling layers of the neural network to control the boundary of the cube padding, no continuous loss is formed on the faces of the cube.

The image feature extraction method of the present invention also uses the temporal training process. After the cube padding model method and the cube padding are used to set the overlapping relationship, and the dimensions of operation layers, convolutional layers and pooling layers of the neural network are used to control the boundary, the LSTM is added in the neural network, and the conventional EQUI method combined with the LSTM 1105 are used.

According to the comparison between the image feature extraction method 1106 using the ResNet-50 model 1107 and VGG-16 model 1108, as shown in FIGS. 11C and 11D, when the resolution of the image is increased, the training speed of the method using the cube padding model method 1305 can be close to the cube padding method. Furthermore, the resolutions of the image tested by the static model of the cube padding model method 1305 and overlapping method are higher than that of the equidistant cylindrical projection method.

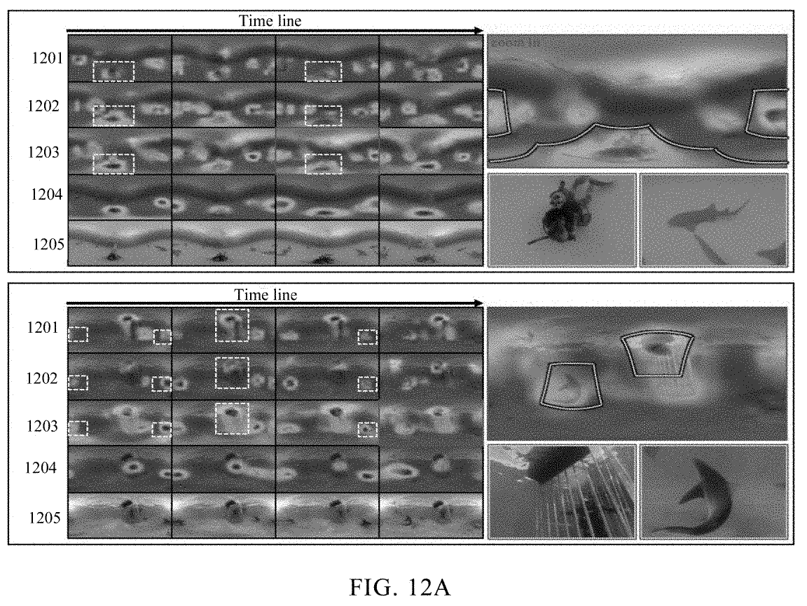

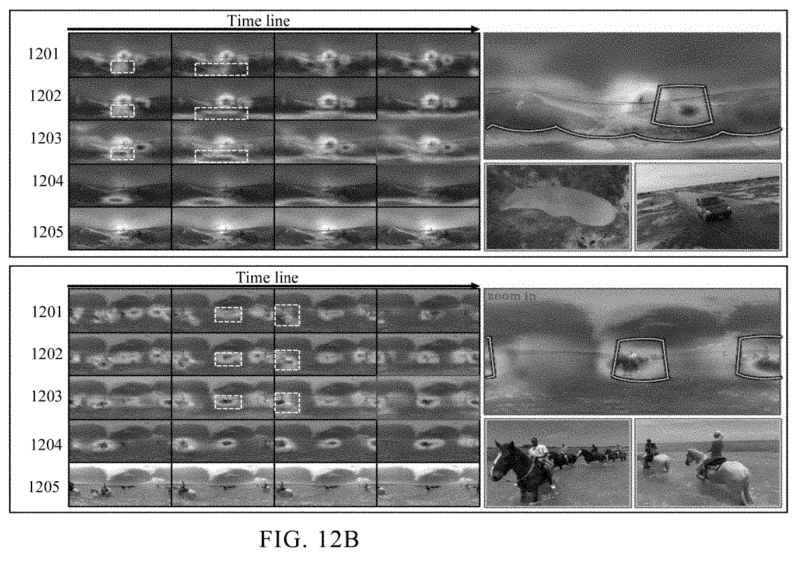

As shown in table 1, the six methods and baseline shown in FIGS. 12A and 12B and the baseline processed by saliency scoring are compared by three saliency prediction methods, and the comparisons between the EQUI method, the overlapping method, the temporal training using LSTM are same as that shown in FIG. 5.

The saliency prediction methods use three AUC for comparison. The first AUC is AUC-J which calculates accuracy rate and misjudgment rate of viewpoints to evaluate a difference between the saliency prediction of the present invention and the basic fact of human vision marking. The second AUC is the AUC-Borji (AUC-B) which samples the pixels of the image randomly and uniformly, and defines the saliency value other than the pixel thresholds to be misjudgment. The third AUC is linear correlation coefficient (CC) method which measures, based on distribution, a linear relation between a given saliency map and the viewpoints, and when the coefficient value is in a range of −1 to 1, it indicates the linear relation exists between the output value of the present invention and the ground truth.

The table 1 also shows the evaluation for the image feature extraction method 1106 of the present invention. Briefly, the image feature extraction method of the present invention uses the cube padding model method 1305 and the cube padding to set the overlapping relationship. Using dimensions of convolutional layers and pooling layers of operation layers of the neural network to control the boundary of the cube padding, no continuous loss is formed on the faces of the cube.

Other conventional baseline motion magnitude, Consistent VideoSa and SalGAN are also compared according to saliency scoring.

As shown in table 1, the image feature extraction method 1106 of the present invention has higher score than other methods, except for the CNN training using ResNet-50 model. As a result, the image feature extraction method 1106 of the present invention has better performance in saliency scoring.

TABLE 1

| | CC | AUC-J | AUC-B |
|---|---|---|---|
| VGG-16 | | | |
| Cube mapping method | 0.338 | 0.797 | 0.757 |
| Overlapping method | 0.380 | 0.836 | 0.813 |
| EQUI method | 0.285 | 0.714 | 0.687 |
| EQUI method + LSTM | 0.330 | 0.823 | 0.771 |
| Cube model method | 0.381 | 0.825 | 0.797 |
| Image feature extraction | 0.383 | 0.863 | 0.843 |
| method of the present invention | | | |
| Resnet-50 | | | |
| Cube mapping method | 0.413 | 0.855 | 0.836 |
| Overlapping method | 0.383 | 0.845 | 0.825 |
| EQUI method | 0.331 | 0.778 | 0.741 |
| EQUI method + LSTM | 0.337 | 0.839 | 0.783 |
| Cube model method | 0.448 | 0.881 | 0.852 |
| Image feature extraction | 0.420 | 0.898 | 0.859 |
| method of the present invention | | | |
| Baseline | | | |
| Motion magnitude | 0.288 | 0.687 | 0.642 |
| ConsistentVideoSal | 0.085 | 0.547 | 0.532 |
| SalGAN | 0.312 | 0.717 | 0.692 |

As shown in FIGS. 12A and 12B, the heat map generated by the actual 360° image trained temporally by the image feature extraction method of the present invention has significantly more red area. This indicates that the image feature extraction method of the present invention can optimize feature extraction performance, as compared with the conventional EQUI method 1201, the cube model 1202, the overlapping method 1203 and the ground truth 1204.

The image distortion is eventually determined by a user. Table 2 shows the scores of cube model method, EQUI method, the cube mapping and the ground truth determined by user. When the user determines no distortion on the image, the win score of the image is added; otherwise, the loss score of the image is added. As shown in table 2, the score of the image feature extraction method 1203 of the present invention is higher than scores of the EQUI method, the cube mapping method, and the method using a cube model and zero-padding. As a result, according to the user's determination, the image feature obtained by the image feature extraction method 1203 of the present invention can approximate an actual image.

TABLE 2

| Method | Win/loss score |
|---|---|
| Cube model method vs. EQUI method | 95/65 |
| Image feature extraction method vs. | 97/63 |
| Cube model method | |
| Cube model method vs. Cube mapping | 134/26 |
| Image feature extraction method vs. | 70/90 |
| Ground truth | |

Please refer to FIGS. 12A and 12B. The image feature extraction method 1203 is compared with the actual plan view 1205 and the actual enlarged view 1207. Significantly, the image feature extraction method 1203 of the present invention has better performance in a heat map than other methods.

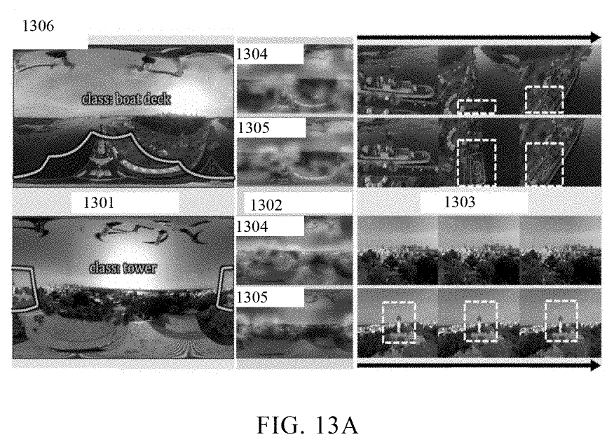

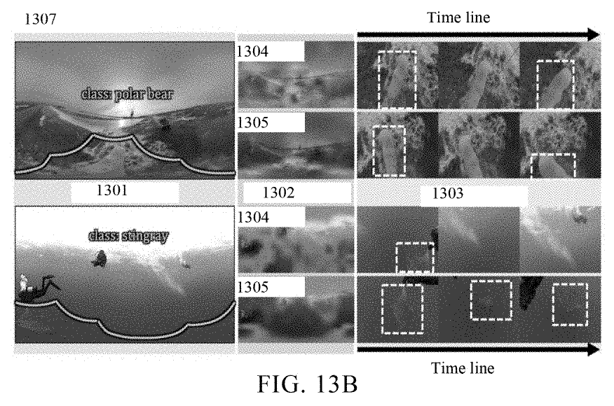

Please refer to FIGS. 13A and 13B. The EQUI method 1304 and the cube padding model method 1305 are used to process the 360° image 1306 captured by Wild-360 1306 and the 360° image 1307 captured by Drone 1307 for comparison. The cube padding model method 1305 has better performance in image extraction on the actual heat map 1302 and normal field of view 1303, and the actual plan view Frame varying over time.

The image feature extraction method of the present invention uses the cube padding model method 1305 and the cube padding to the overlapping relationship. The dimensions of convolutional layers and pooling layers of the operation layers of the neural network to control the boundary of the cube padding are also used, so that no continuous loss is formed on the faces of the cube. Furthermore, the application of the feature extraction method and saliency prediction method for 360° image is not limited to aforementioned embodiments; for example, the feature extraction method of the present invention can also be applied to 360° image camera movements editing, smart monitoring system, robot navigation, perception and determination of artificial intelligence for the wide-angle content.

The present invention disclosed herein has been described by means of specific embodiments. However, numerous modifications, variations and enhancements can be made thereto by those skilled in the art without departing from the spirit and scope of the disclosure set forth in the claims.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. An image feature extraction method using a neural network for a 360° image, comprising:
projecting the 360° image to a cube model, to generate an image stack comprising a plurality of images comprising a link relationship;
using the image stack as an input of the neural network, wherein when operation layers of the neural network are used to perform padding computation on the plurality of images, to-be-padded data is obtained from neighboring image of the plurality of images according to link relationship, so as to reserve features of image boundaries; and
using the operation layers of the neural network to generate a padded feature map, and extracting an image feature map from the padded feature map.

2. The image feature extraction method according to claim 1, wherein the operation layers are used to compute the plurality of images, to generate the plurality of padded feature maps comprising the link relationship to each other, so as to form a padded feature map stack.

3. The image feature extraction method according to claim 2, wherein when the operation layers of the neural network perform the padding computation on one of the plurality of padded feature maps, the to-be-padded data is obtained from the adjacent padded feature maps of the plurality of padded feature maps according to the link relationship.

4. The image feature extraction method according to claim 1, wherein the operation layers include a convolutional layer or a pooling layer.

5. The image feature extraction method according to claim 4, wherein a dimension of a filter of the operation layers controls the operation of obtaining the range of the to-be-padded data according to the neighboring images of the plurality of images.

6. The image feature extraction method according to claim 1, wherein the cube model comprises a plurality of faces, and the image stack with a link relationship is generated according to a relative positional relationship between the plurality of faces.

7. A saliency prediction method for a 360° image, comprising
projecting the 360° image to a cube model, to generate an image stack comprising a plurality of images comprising a link relationship;
using the image stack as an input of a neural network, wherein when operation layers of the neural network are used to perform padding computation on the plurality of images, to-be-padded data is obtained from neighboring image of the plurality of images according to link relationship, so as to reserve features of image boundaries;
using the operation layers of the neural network to generate a padded feature map, and extracting an image feature map of the 360° image from the padded feature map;
using the image feature map as a static model;
performing saliency scoring on pixels of images of the static model, to obtain a static saliency map;
adding a LSTM in the operation layers, to gather the plurality of static saliency maps at different times, and performing saliency scoring on the gathered static saliency maps to obtain a temporal saliency map; and
using a loss function to optimize the temporal saliency map at a current time point according to the temporal saliency maps at previous time points, so as to obtain a saliency prediction result of the 360° image.

8. The saliency prediction method according to claim 7, wherein the operation layers are used to compute the plurality of images, to generate the plurality of padded feature maps comprising the link relationship to each other, so as to form a padded feature map stack.

9. The saliency prediction method according to claim 8, wherein when the operation layers of the neural network perform the padding computation on one of the plurality of padded feature maps, the to-be-padded data is obtained from the adjacent padded feature maps of the plurality of padded feature maps according to the link relationship.

10. The saliency prediction method according to claim 7, wherein the operation layers include a convolutional layer or a pooling layer.

11. The saliency prediction method according to claim 10, wherein a dimension of a filter of the operation layers controls the operation of obtaining the range of the to-be-padded data according to the neighboring images of the plurality of images.

12. The saliency prediction method according to claim 7, wherein the cube model comprises a plurality of faces, and the image stack with a link relationship is generated according to a relative positional relationship between the plurality of faces.
